(19) United States
(12) Patent Application Publication
(10) Pub. No.: US 2025/0145481 A1
(43) Pub. Date: May 8, 2025

(54) Ammonia Synthesis Using A Reaction Apparatus

(71) Applicant: Siemens Aktiengesellschaft, München (DE)

(72) Inventor: Christoph Kiener, München (DE)

(73) Assignee: Siemens Aktiengesellschaft, München (DE)

(21) Appl. No.: 18/934,449

(22) Filed: Nov. 1, 2024

(30) Foreign Application Priority Data
Nov. 2, 2023 (EP) 23207360.1

(51) Int. Cl. C01C 1/04

(52) U.S. Cl. CPC C01C 1/0452

(57) ABSTRACT

Various embodiments of the teachings herein include a process for ammonia synthesis. An example includes: passing a feed gas via an inlet opening over a catalyst within a reactor, wherein the feed gas comprises nitrogen and hydrogen under pressure; passing ammonia produced in the reactor as a wet gas to a condensation unit comprising three heat exchangers configured monolithically with one another, wherein the ammonia condenses; and discharging the subcooled liquid pressurized condensate through a collection channel and discharging the dry gas via an outlet opening. The first heat exchanger causes the wet gas to exchange heat with a dry gas from which ammonia has already condensed, producing a cooled wet gas. The second heat exchanger separates the wet gas into gaseous reactants and a liquid pressurized condensate. The third heat exchanger subcools the liquid pressurized condensate.

### CROSS-REFERENCE TO RELATED APPLICATIONS

This application claims priority to EP Application Serial No. 23207360.1 filed Nov. 2, 2023, the contents of which are hereby incorporated by reference in their entirety.

### TECHNICAL FIELD

The present disclosure relates to ammonia synthesis. Various embodiments include methods and/or systems using a reaction apparatus to synthesize ammonia.

### BACKGROUND

Ammonia, which has the chemical formula NH₃, is a particularly important commodity chemical and was produced in an amount in the order of 140 million tons in the year 2020 for example. The starting materials for the Haber-Bosch process, which was invented around 120 years ago and is the standard process for ammonia synthesis, are hydrogen (H₂) and nitrogen (N₂). Ammonia is formed in an equilibrium reaction from the elements hydrogen and nitrogen according to the equation:

N₂+3H₂ [symbol] 2NH₃.

It is generally the case that the required nitrogen is taken from ambient air, wherein the oxygen present in the air is for example separated and the nitrogen: purified by air fractionation processes. Hydrogen, the energy-containing starting material for ammonia synthesis, has been provided almost exclusively via fossil energy sources for one hundred years.

Downstream products for which ammonia is used as the starting material include for example urea and ammonium and nitrate fertilizers, with more than 80% of worldwide production of ammonia being used for fertilizer. Furthermore, a very wide variety of chemical products, for example polyamides for textile fibers, plastics and materials, Duroplast-melamine resins, explosives, reducing agents in flue gas denoxing and the like, are produced on the basis of ammonia. The use of NH₃ as a hydrogen storage substance and also as an energy carrier is also being discussed.

Ammonia synthesis currently consumes almost 2% of all fossil energy sources. Ammonia production also results in about 500 million tons of CO₂, representing approximately 2% of anthropogenic CO₂ emissions from energy sources, which is certainly a remarkably large amount for a single product molecule. It would be desirable to produce green ammonia without greenhouse gas emissions, which is already an important topic of discussion in the chemical industry, though this has not yet been widely implemented due to complex plants and operating concepts and a lack of available CO₂-neutral, so-called green, electrolytic hydrogen. Climate-neutral ammonia is even being discussed as a hydrogen carrier between Australia and Europe in the form of fuel for container ships, which could lead to a significant CO₂ reduction in shipping.

An innovative, fully automated, and flexibly operated so-called green ammonia plant (green ammonia) with water electrolysis in a decentralized electricity grid could be an attractive option for decentralized, CO₂-free ammonia synthesis as an energy storage means or in conjunction with appropriate sustainable fertilizer synthesis.

Economic, technological and operational reasons against the use of hydrogen from renewable energies in ammonia synthesis presently include: decentrality: since small plants generally entail a particularly small amount of end products relative to production costs; fluctuation: since hydrogen from renewable energies is generally only available inconsistently and without storage continuous operation of ammonia synthesis is impossible; automation: small unconventional plants are generally not fully automatic and are therefore too costly in operation on account of personnel costs; efficiency: ammonia synthesis is favored by high pressure which must be provided cost-effectively. In addition, industrial scale processes carried out on a small scale are always complicated.

### SUMMARY

Teachings of the present disclosure provide processes and reaction apparatus for ammonia synthesis which are particularly scalable especially with regard to small plants and also particularly efficient. For example, some embodiments of the teachings herein include a process for ammonia synthesis with a reaction apparatus (10) in whose reactor means (12) feed gas (14) which comprises at least nitrogen and hydrogen as reactants is passed over a catalyst (60) under pressure via an inlet opening to form ammonia as product and this is passed as wet gas (19) to a condensation means (16) comprising at least three heat exchange units (24, 26, 28) configured monolithically with one another in order to flow therethrough, wherein the ammonia is condensed as condensate (20), wherein the first heat exchange unit (24) is operated as a countercurrent cooler, thus causing the wet gas (19) to exchange heat with dry gas (22) from which ammonia has already condensed, and the second heat exchange unit (26) is operated as a condenser, thus separating the gaseous reactants from the liquid pressurized condensate (20), and the third heat exchange unit (28) is operated as an aftercooler and accordingly the pressurized condensate (20) is subcooled and discharged via a collection channel (30) and the dry gas (22) is discharged via an outlet opening.

In some embodiments, the reactor means (12) comprises a reaction space (32) especially configured monolithically with the condensation means (16) which is in the form of a preheating unit (36) and a second reactor (35) surrounded by a heat pipe heat exchange reservoir (38) and of a first reactor (34) surrounded by a heat pipe heat recovery reservoir (40) and by means of which the feed gas (14) is preheated and brought to reaction.

In some embodiments, the reaction space (32) is formed by a pressure vessel and the feed gas (14) is introduced into the reaction space (32) at at least 300 and in particular 400 bar and particularly preferably 500 bar.

In some embodiments, the pressure of the feed gas (14) is generated using an ionic compressor (62).

In some embodiments, a plurality of reactor passes are performed successively in a cascade, and to this end especially a corresponding number of especially monolithically manufactured reaction apparatuses (10) are connected in series.

As another example, some embodiments include a reaction apparatus (10) for a process as described herein comprising a reactor means (12) and a condenser means (16) which comprises at least three heat exchange units (24, 26, 28) configured monolithically with one another, of which the first heat exchange unit (24) is in the form of a countercurrent cooler, the second heat exchange unit (26) is in the form of a condenser and the third heat exchange unit (28) is in the form of an aftercooler.

In some embodiments, the first heat exchange unit (24) is formed by a plurality of solid plates (42) arranged spaced apart from one another in parallel and respective sets of two adjacent plates (42) form a respective plate channel (44) and the second heat exchange unit (26) is formed by porous demister plates (46) which in each case seamlessly extend the plates (42) of the first heat exchange unit (24) and the third heat exchange unit (28) is formed from alternating apposed solid plates (48) and porous collection plates (50) which are arranged substantially perpendicular to the plates (42, 46) of the first and second heat exchange unit (24, 26) and comprise at least one cooling channel (52) and in an end region (56) in a condensation direction (54) comprise a collection channel (30).

In some embodiments, the reaction apparatus (10) comprises a plurality of reactor means (12) and condensation means (16) and/or the reactor means (12) and the condensation means (16) is or are in particular formed as one piece and/or additively manufactured individually and/or in combination.

In some embodiments, a material of the reactor means (12) and/or of the condensation means (16) exhibits long-term stability towards high pressure and/or high temperature and/or ammonia and/or hydrogen and/or nitrogen.

In some embodiments, the material comprises NiCr22Mo9Nb and/or NiCr19Fe19Nb5Mo3 and/or has a thermal conductivity of less than 15 and in particular 11 W/(m*K), thus making it possible to establish a temperature gradient, especially along the condensation direction (54).

### BRIEF DESCRIPTION OF THE DRAWINGS

In the drawings:

FIG. 1 is a schematic flow diagram of an example ammonia synthesis reaction apparatus comprising a reactor means and a condensation means incorporating teachings of the present disclosure;

FIG. 2 is a schematic perspective view of an example condensation means incorporating teachings of the present disclosure;

FIG. 3 is a schematic sectional view of a section of the condensation means according to FIG. 2;

FIG. 4 is a schematic perspective view of an example reactor means of the reaction apparatus incorporating teachings of the present disclosure;

FIG. 5 is a further schematic flow diagram which shows provision of the reactants for the reaction apparatus or the process; and

FIG. 6 is a further schematic flow diagram of the process, wherein a plurality of reaction passes are performed successively in cascaded fashion.

### DETAILED DESCRIPTION

Some examples of the teachings herein include a process for ammonia synthesis using a reaction apparatus. In an example process, separation of the NH₃ product is achieved when gaseous fluid or feed gas comprising at least N₂ and H₂, i.e. nitrogen and hydrogen, as reactants is passed over a catalyst under pressure via an inlet opening into a reactor means of the reaction apparatus to form ammonia as product and this is passed in gaseous form especially with further products as wet gas to a condensation means comprising at least three heat exchange units configured monolithically with one another or especially serially along a condensation direction in order to flow therethrough, wherein the ammonia NH₃ product is condensed as condensate from the introduced, especially wet, gas. To this end the first heat exchange unit is operated as a countercurrent cooler or feed-effluent exchanger, thus causing the feed gas to exchange heat with dry gas or tail gas from which ammonia has already condensed, and the second heat exchange unit which especially seamlessly adjoins or functionally extends the first heat exchange unit is operated as a condenser, thus separating the gaseous reactants from the liquid pressurized condensate or product, and the third heat exchange unit is operated as an aftercooler to subcool the pressurized condensate, which is discharged, especially at room temperature, via a collection channel and the dry gas or tail gas is further discharged from the reaction apparatus via an outlet opening.

The monolithic condensation means may especially be formed or manufactured or produced by additive manufacturing. The compact and thus apposed different functional units—the heat exchange units-result in a particular structural strength and on account of the geometry in a desired conductivity or thermal integration especially in the case of exergetic optimization, so that for example a low dissipation of waste heat into the cooling water can be made possible.

In other words, two or more heat exchangers and a phase separator which is formed by the second and third heat exchange unit in the transition region thereof are formed from a block produced by additive manufacturing and/or comprising at least one partially metallic material. Ammonia synthesis by means of this process is an equilibrium reaction, wherein the chemical equilibrium is shifted to an attractive region especially at high pressure. It is thus possible to achieve a high reaction rate even at 400° C. and at the same time an acceptable position of the equilibrium through 500 bar (50 MPa) of pressure, thus making it possible to use a particularly small amount of catalyst. Conversions of for example 60% are achievable, thus allowing a much higher reaction rate and product yield compared to conventional processes, typically carried out at 200 bar and 330° C., on account of the chemical equilibrium, allowing a particularly high efficiency in ammonia synthesis.

In some embodiments, the reactor means comprises a reaction space especially configured monolithically with the condensation means which is in the form of a preheating unit and a second reactor surrounded by a heat pipe heat exchange reservoir and of a first reactor surrounded by a heat pipe heat recovery reservoir which is operated for example with naphthalene at up to about 430° C., by means of which the gaseous fluid or feed gas is preheated and brought to reaction. In other words, a first reaction zone which is advantageously formed by tubes in a heat bath is provided. This allows high-temperature heat to be emitted for example into a useful heat system which is utilized for preheating the wet gas or feed gas. This has the advantage that it is particularly exergetically advantageous-it is thus possible for example to initially use the low temperature level of for example 350° C. to effect further heating with reaction heat and to extract heat at higher temperatures as useful heat via the heat pipes for example.

In some embodiments, the reaction space is formed by a pressure vessel or enclosed by a pressure vessel and thus delimited thereby so that the gaseous fluid or feed gas is or can be introduced into the reaction space at at least 300 and in particular 400 bar and particularly preferably 500 bar. In other words, the reaction apparatus is configured such that the reaction or the condensation can be performed at a particularly high pressure which is above 300 bar and may be 500 bar. This brings about a particularly high reaction yield.

In some embodiments, the pressure of the feed gas is generated using an ionic compressor or a compressor with ionic liquid. In other words, an isothermally operating displacement processor, which can remove heat generated by an ionic liquid during compression in the interior is used to compress the dry gas or feed gas. The gas can be compressed to particularly high pressures and in this case particularly efficiently.

In some embodiments, a plurality of reaction passes may be performed or carried out successively in a cascade, wherein to this end especially a corresponding number of especially monolithically manufactured reaction apparatuses are connected in series. In some embodiments, the respective reactor means of the respective reaction apparatus comprises a respective heat exchange reservoir with preheating unit and second reactor or is configured together therewith. In other words, the reaction apparatus may comprise a plurality of reactor means and condensation means which are fluidically connected in series so that dry gas issuing from a first condensation means in the flow direction of the fluid flows into the next reactor means virtually as feed gas. It is thus possible for example to achieve a particularly high yield via an intermediate condensation because ammonia may be withdrawn from the equilibrium in each case. The cascade has the result that the product can in each case condense out in each pass, wherein only unavoidable heat losses, especially in an axial heat conduction (in the respective condensation means) the heat liberated in the condensation through cooling, are dissipated into the cooling water. The heat in the hot product stream of the feed gas is used to heat the tail gas from the condenser. Useful heat can be extracted from the heat recovery reservoir of the first reactor at 400° C. A particularly high ammonia yield can be achieved.

Some embodiments of the teachings herein include a reaction apparatus for a process as described herein. An example reaction apparatus comprises a reactor means which comprises a preheating unit, a first reactor, and a second reactor, and a condenser means which comprises at least three heat exchange units configured monolithically with one another or serially which especially functionally transition into one another, wherein of the heat exchange units the first heat exchange unit is in the form of a countercurrent cooler or feed-effluent exchanger, the second heat exchange unit is in the form of a condenser and the third heat exchange unit is in the form of an aftercooler, wherein the second heat exchange unit and part of the third heat exchange unit together form a phase separator which serves to separate the condensate of the ammonia from the gas.

In some embodiments, the first heat exchange unit which is in particular in the form of a countercurrent cooler is formed by a plurality of solid plates arranged spaced apart from one another in parallel, wherein respective sets of two adjacent plates form a respective plate channel which is especially oriented along a condensation direction. Adjacent plate channels are open on alternate sides. In addition, the second heat exchange unit is formed by porous demister plates which in each case seamlessly extend the plates of the first heat exchange unit or transition into these but can change a circumference or the like for example. In addition, the third heat exchange unit, which is especially in the form of a condensate cooler, is formed from alternating apposed solid plates and porous collection plates which are arranged substantially perpendicular to the plates of the first and second heat exchange unit and comprise at least one cooling channel or at least two cooling channels for passage of especially cold coolant and in an end region in a condensation direction comprise a collection channel for the condensate.

In other words, the condensation means is formed from heat exchange units which are functionally connected or transition into one another so that especially the porous region of the second and third heat exchange units which seamlessly transition into one another forms the condenser or phase separator. Depending on the heat capacity of the employed material of the especially additively manufactured condensation means it may be possible to form a temperature gradient over the cooling channels up to the first heat exchange unit. The alternately open plates give the option of countercurrent cooling or of the feed-effluent cooler so that especially at the end opposite the second and third heat exchange units the feed gas flows into a respective plate channel and through a porous demister plate in the heat exchange unit into the next adjacent plate channel where the dry gas can flow back out to the upper end of the first heat exchange unit through the plate channel. The reaction apparatus is configurable for particularly efficient operation. This further enables particularly efficient performance of the processes described herein.

In some embodiments, the reaction apparatus comprises a plurality of reactor means and condensation means configured especially monolithically y with one another. In some embodiments, the respective condensation means or plurality of combined or flanged-together condensation means and/or reactor means are formed as one piece and/or additively manufactured. In other words, in order to allow a particularly low heat loss for the process a plurality of the condensation means and reactor means are combined, thus allowing cascaded performance of a plurality of passes essentially without extra conduits such as for example channels or pipes. In addition, the respective condensation means may be one-piece, i.e. especially seamlessly produced from one workpiece especially by additive manufacturing. This allows for example cost-effective provision of the reaction apparatus. Furthermore, the functionality of for example the condensation means may be provided particularly reliably.

In some embodiments, a material of the (respective) reactor means and condensation means exhibits long-term stability towards high pressure and/or high temperature and/or ammonia and/or hydrogen and/or nitrogen. In other words, the material which, for example, is especially a metallic alloy is selected such that the condensation means and thus the reaction apparatus may be made as durable as possible for ammonia synthesis. Wear may be particularly low, with the result that the reaction apparatus or the process may be made particularly cost-effective.

In some embodiments, the material comprises the alloy with EN number 2.4856, DIN NiCr22Mo9Nb, also known as Inconel® 625 or IN625, and/or with EN number 2.4668, DIN NiCr19Fe19Nb5Mo3, also known as INCONEL® 718 or IN718, and/or the material has a thermal conductivity of less than 15 and in particular of 11 W/(m*K), with the result that a temperature gradient can be established or formed in the respective condensation means along the condensation direction (i.e. axially). On account of the respective plates for the respective plate channels which are thin and have a certain length it is thus possible to achieve a very low heat loss in the direction of the temperature gradient, wherein despite the poor thermal conductivity a sufficient amount of heat can still be exchanged by the thin plates in the radial direction. In other words, the material is adapted to a desired temperature gradient. The proposed reaction apparatus makes it possible to perform the process particularly efficiently.

For application cases or application situations that may arise in the process and that are not described explicitly here, provision may be made, according to the process, for an error message and/or a request for input of user feedback to be output and/or a default setting and/or a predetermined initial state to be set.

Irrespective of the grammatical gender of a specific term, persons with male, female or other gender identity are also included.

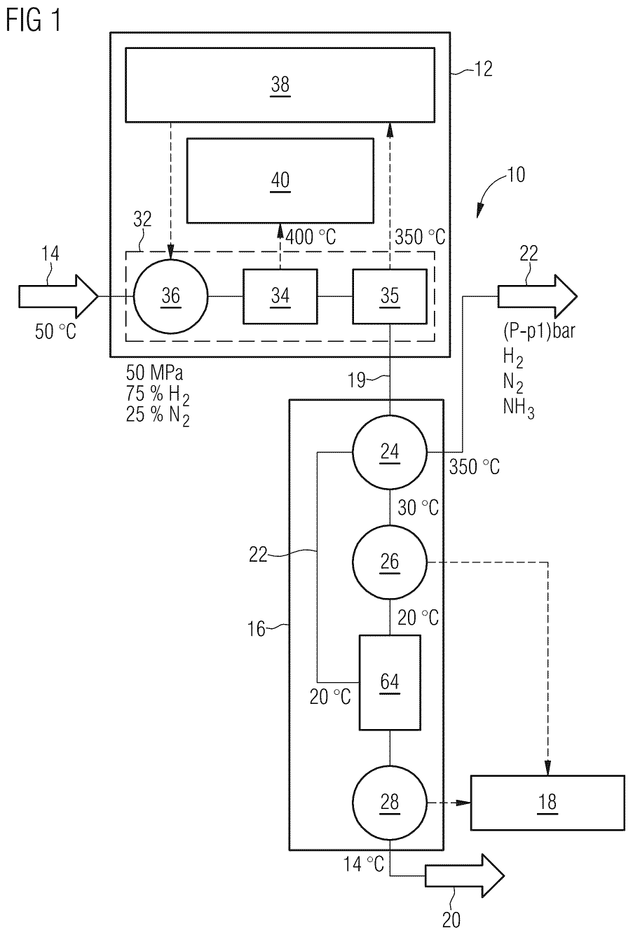

FIG. 1 shows a schematic flow diagram for an example process incorporating teachings of the present disclosure for ammonia synthesis using a reaction apparatus 10 which comprises reactor means 12 and condensation means 16. In the process, feed gas 14 which comprises at least nitrogen and hydrogen as reactants is passed over a catalyst 66 under pressure via an inlet opening to form ammonia as product in chemical equilibrium in a reaction space 32 of the reactor means 12. The especially gaseous ammonia forms a wet gas 19 with the residues of the feed gas 14 or with any further byproducts formed therefrom. However, no byproducts are generally formed. The expression “wet gas” indicates that said gas contains at least one product that would be desirable to condense out.

Accordingly, the wet gas is passed from the reactor means into a condensation means 16 which comprises at least three heat exchange units configured monolithically with one another or serially and in which the ammonia product is condensed out of the introduced gas as condensate 20. The first heat exchange unit 24 is operated as a countercurrent cooler which effects heat exchange between the wet gas 19 and the dry gas 22 or tail gas from which ammonia has already been condensed. The second heat exchange unit 26 is operated as a condenser and separates the gaseous reactants or the gaseous fluid from the liquid pressurized condensate 20. The third heat exchange unit 28 is operated as an aftercooler and subcools or further cools the pressurized condensate 20, in particular to room temperature. This subcooled condensate 20 is discharged via a collection channel 30 and the dry gas 22 via an outlet opening.

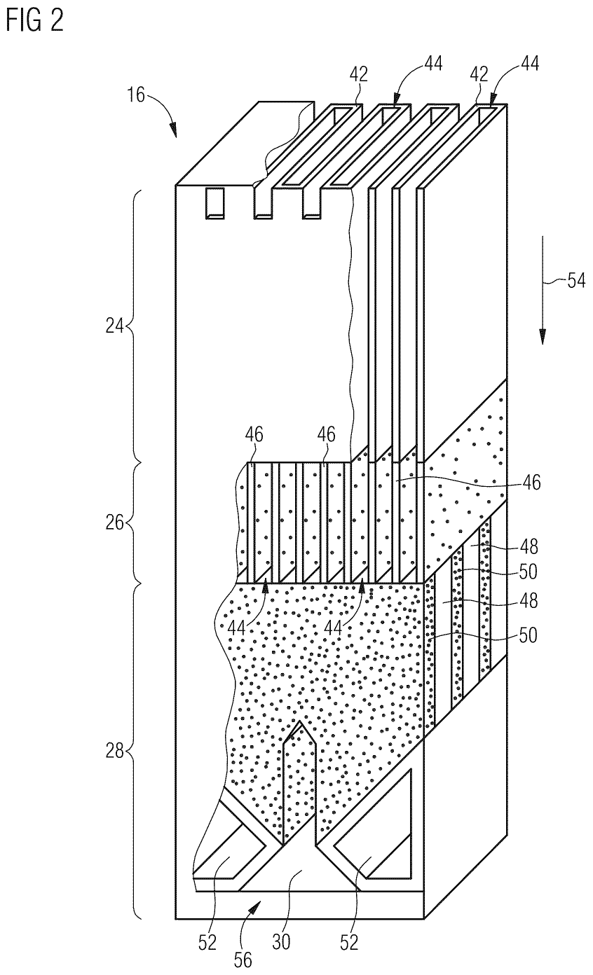

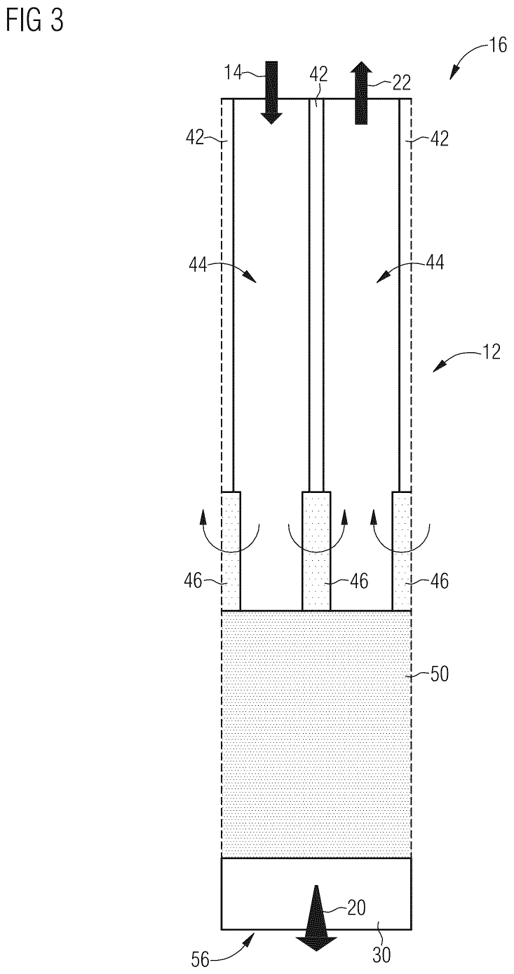

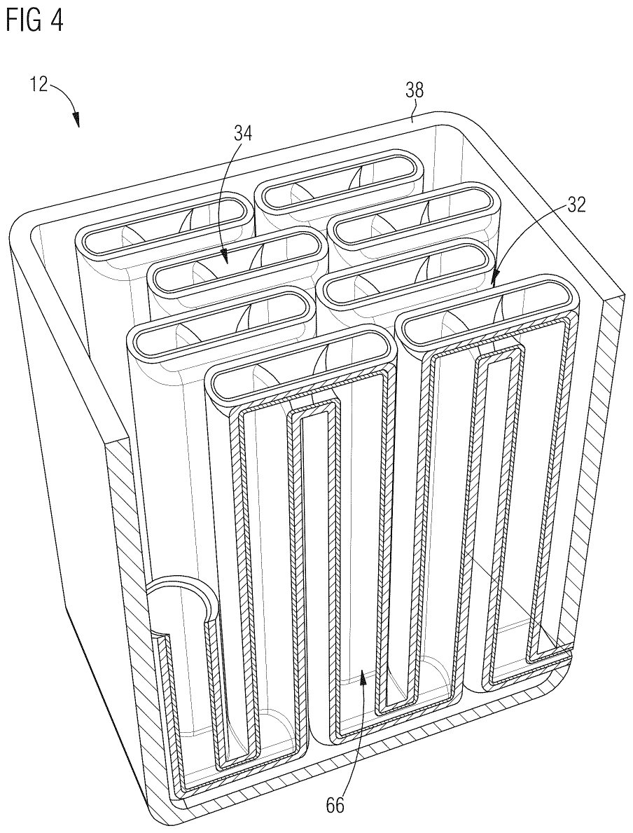

In some embodiments, the condensation means 16 (see FIGS. 2 and 3) is configured monolithically with the reactor means 12 (see FIG. 4) which forms a preheating unit 36 which is especially formed by a first reactor 34 surrounded by a heat pipe temperature control unit. This allows preheating of the feed gas 14.

In some embodiments, the reaction space 32 contains the preheating unit 36 and a second reactor 35 surrounded by a heat exchange reservoir 38 in the form of a heat pipe heat exchange reservoir and also the first reactor 34 surrounded by a heat recovery reservoir 40 in the form of a heat pipe heat recovery reservoir. In the reaction space 32 the feed gas 14 is preheated and brought to reaction.

In some embodiments, the reaction space 32 is delimited by a pressure vessel or formed thereby so that the feed gas 14 may be introduced into the reaction space 32 at particularly high pressure, at least 400 and in particular 500 bar.

For example, in the process shown in FIG. 1 the feed gas 14 may have a temperature of 50° C., a hydrogen proportion of 75% and a nitrogen proportion of 25% before reaching the preheating unit 36. To allow introduction of the gas into the pressure vessel or the reaction space 32 at the prevailing pressures it is possible to provide an ionic compressor which thus provides 500 bar compression technology, especially for small systems, such as the reaction apparatus 10.

In the preheating unit 36 the temperature of the feed gas 14 is heated to 400° C. or at least 350° C. using a cooling medium, for example cooling water or naphthalene, which is cyclically evaporated and condensed in the heat pipe temperature control unit. Thus, the wet gas 19 also has a temperature of at least 350° C.

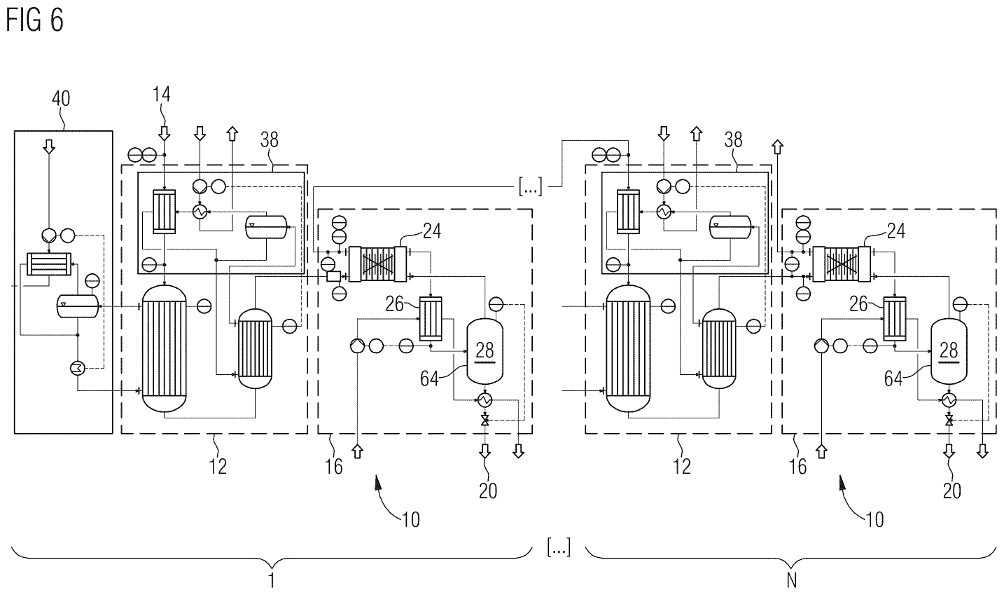

The wet gas 19 is then fed into the condensation means 16 at this temperature and a pressure of 50 MPa. The first heat exchange unit 24 present there is operated as a countercurrent cooler so that the wet gas 19 flows through a first plate channel 44 to the second heat exchange unit 26 for phase separation and then flows back as dry gas 14 in an adjacent plate channel 44 to the end of the first heat exchange unit 24 facing away from the second heat exchange unit 26. There, the dry gas 22 exits the condensation means 16 at a temperature of for example 350° C. by being discharged for example via a venting opening or in an advantageous embodiment being passed directly into a further reaction apparatus 10 or reactor means 12 in order for example to allow a plurality of cascading reactor passes or successive reaction passes. This is discussed in more detail in FIG. 6.

The second heat exchange unit 26 serves as a condenser in which the condensate 20 is separated from the gas, wherein this occurs at a temperature of for example 30° C. and the second heat exchange unit 26 may thus be used or is used as a cooler and phase separator 64.

In the figures a heat sink 18, the heat exchange reservoir 38, and the heat recovery reservoir 40 symbolize the operating temperature specified by the respective cooling medium or the respective cooling liquid. The heat exchange unit 28 is thus cooling-water cooled for example using a further cooling medium to allow subcooling of the condensate 20 to for example 14° C. or room temperature.

FIG. 2 shows a schematic perspective view of a condensation means 16 for a reaction apparatus 10 for performing the process described herein. FIG. 2 shows the condensation means 16 without a housing or wall, which forms a further pressure vessel. The condensation means 16 comprises at least three heat exchange units 24, 26, 28 configured with one another, of which the first heat exchange unit 24 is in the form of a countercurrent cooler, the second heat exchange unit 26 is in the form of a condenser and the third heat exchange unit 28 is in the form of an aftercooler.

The first heat exchange unit 24 is formed by a plurality of solid plates 42 arranged spaced apart from one another in parallel, wherein each set of two adjacent plates 42 forms a plate channel 44 which is in each case substantially oriented axially along a condensation direction 54 and the plate channels 44 are open on alternate sides so that as a result of the respective plate channel 44, which extends right up to the second heat exchange unit 26 since the second heat exchange unit 26 is configured such that the respective first plates 42 are seamlessly extended by porous demister plates 46, a phase separation is possible in the second heat exchange unit, and as a result of the alternate-side opening of the plate channels 44 the first heat exchange unit 24 can thus be operated as a countercurrent cooler. Finally, the third heat exchange unit 28 is formed from alternately apposed solid plates 48 and porous collection plates 50 which are arranged substantially perpendicular to the plates 42 and 46 of the first and second heat exchange units 24 and 26. The third heat exchange unit 28 comprises at least one cooling channel 52 and the collection channel 30 for the condensate 20 which is especially in an end region 56 in the condensation direction 54.

FIG. 3 shows in a schematic sectional view a section of the condensation means 16, wherein the transition of the solid plates 42 into the porous demister plates 46 is shown, so that respective adjacent plate channels 44 are used for inflow of the feed gas 14 and for outflow of the dry gas 22. In the lower end region 56 the condensate 20 is discharged via the collection channel 30 while it is further cooled by the third heat exchange unit 28. The porous material of the porous demister plates 46 transitions into the porous material of the porous collection plates 50 which for particularly advantageous cooling are in each case surrounded by the interposed solid cooling plates-plates 48.

In some embodiments, the material of the condensation means 16 exhibits long-term stability towards high pressure and/or high temperatures and/or ammonia and/or hydrogen and/or nitrogen and the reaction apparatus 10 may therefore be made particularly durable. In some embodiments, the material comprises for example the alloy IN625 and/or IN718, wherein the former has a thermal conductivity of, for example, 10 W/(m*K), thus making it possible to establish a temperature gradient, especially along the condensation direction 54, a temperature gradient therefore being establishable especially also on account of the thin wall thickness of the plates 42 and 46 and therefore axially or in the condensation direction 54.

FIG. 4 shows in a schematic perspective view a preheating unit 36 formed by a first reactor 34 surrounded by a heat pipe temperature control unit. The reactants or the feed gas 14 are conveyed in the direction of or to the condensation means 16 through tubes of the first reactor 34 and preheated via a cooling medium represented for example via the heat exchange reservoir 38 or heat recovery reservoir 40. Cooling media employable in the heat pipe temperature control unit include for example naphthalene which is passed through the heat pipes of the heat pipe temperature control unit at for example 400° C. and accordingly heats the feed gas introduced for example at 50° C. to 350° C. to 400° C. for the condensation means 16.

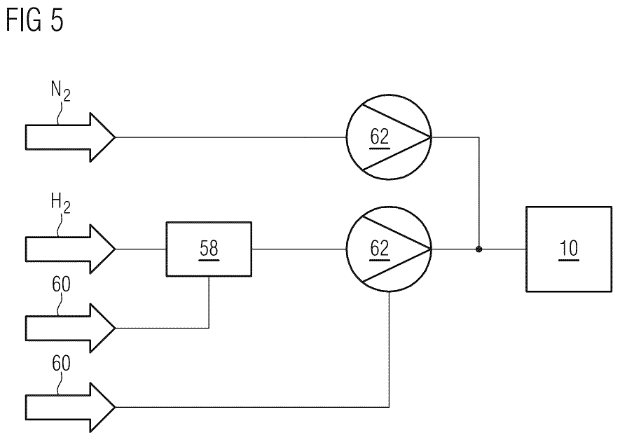

FIG. 5 is a schematic view of a flow diagram for an example process incorporating teachings of the present disclosure in which the starting materials are provided and passed to the reaction apparatus 10. Hydrogen H₂ is obtained via an electrolyzer 58 which is supplied with electricity 60, wherein the electrolyzer 58 is advantageously coupled to the heat recovery reservoir 40 or at least has the temperature thereof. Both nitrogen and hydrogen are conveyed to the reaction apparatus 10 using compressors 62.

FIG. 6 shows a plurality of jointly configured reaction apparatuses 10 which each comprise a condensation means 16 and a reactor means 12 and are connected in series so that a plurality of reactor passes or passes of the process may be performed successively in a cascade. In FIG. 6 “[ . . . ]” is used to indicate that virtually any number of further reaction apparatuses 10 may be arranged here between the first and the last reaction apparatus 10. For example, five reaction apparatuses 10 may be connected in series and condensate 20 may be discharged from each, wherein in each case the dry gas 22 discharged from the preceding condensation means 16 is used as feed gas 14 for the next reactor means 12.

The reaction apparatus 10 thus makes it possible to provide a highly integrated reactor which may be manufactured for example by additive manufacturing, especially by powder bed fusion. Additive manufacturing results in a particularly high structural strength for the condensation means 16 and in an advantageous geometry for thermal conductivity or thermal integration.

The reaction apparatus 10 enables a complexity bundling for the ammonia synthesis in particular by cascading of a plurality of reactor means 12 and condensation means 16 and via the option of common heat exchange, for example via the heat sink 18, the heat exchange reservoir 38 and the heat recovery reservoir 40, thus making it possible to achieve multistage product condensation of the condensate 20.

The use of alloys exhibiting long-term stability such as IN625 and/or IN718 makes it possible to allow particularly demanding shapes through additive manufacturing. The strength values of the alloys are suitable for example for particularly thin wall thicknesses of 1 mm or less with appropriate reinforcement using a reinforcing structure for example, thus making it possible to realize high pressure differences for the pressure vessel for example.

It is because of the interaction of the reactor means 12 which comprises the preheating unit 36 and is formed monolithically with the three heat exchange units 24, 26 and 28 and facilitates precisely this exchange that the reactor means 12 forms for example a plurality of reaction regions or zones or the first reactor 34 and the second reactor 35. These may operate or be operated at different temperatures, for example 400° C. and 350° C. The two reaction zones or reactors 34 and 35 firstly make it possible to achieve high conversions (temperature higher, faster conversion) while nevertheless favoring chemical equilibrium (temperature lower, residual amount conversion up to equilibrium).

High-temperature heat is emitted for example to the useful heat system via the heat pipes of the heat pipe temperature control unit which is used for preheating the feed gas 14. It can be exergetically advantageous to initially utilize and heat further with reaction heat the lower temperature level of for example 350° C. of the second reaction zone and to extract heat from the first reaction zone at higher temperature as useful heat.

It is made possible via the first heat exchange unit 24 for a heat exchanger to avoid heat losses. Condensation in the second heat exchange unit 26 and subcooling of the pressurized condensate 20 in the third heat exchange unit 28 to room temperature is made possible.

At a thermal conductivity of only 11 W/(m*K) the alloy IN625 has a particularly low thermal conductivity for a metallic material. Long components of thin wall thickness in the direction of the temperature gradient therefore lose very little heat in the axial direction and are capable of establishing a temperature gradient. Thin plates, for example plates 42 and 46, still exchange a sufficient amount of heat in the radial direction despite the poor thermal conductivity.

In order to achieve the desired pressure of 50 MPa or 500 bar overall, a compressor with ionic liquid is used which for example can also compress small amounts of for example 18 kg of hydrogen per hour to a pressure of 500 bar and can do this for example in compact units of 10 tons in a container. At least one of the compressors 62 may be in the form of an ionic compressor.

The reactor system or the first reactor 34 in the heat bath of the heat pipe cooler may for example be operated particularly efficiently on account of the additive manufacturing, since for example functional elements may be manufactured simultaneously without additional cost and complexity.

The cascading shown in FIG. 6 allows the ammonia product or the condensate 20 to be condensed out in each case in the respective condensation means 16, wherein only the unavoidable heat loss via axial heat conduction or along the condensation direction 54 in the respective condensation means 16 and the heat liberated during condensation and subcooling are dissipated into the cooling water. The heat in the hot product stream, i.e. from the respective feed gas 14, is used to heat the tail gas from the condenser. Useful heat is extracted especially at 400° C.

Some embodiments provide process engineering advantages, for instance the chemical equilibrium can be shifted to an attractive region upon operation at very high pressure. At 500 bar, conversions of for example 60% are achievable even at 400° C., wherein a high reaction rate is achieved and little catalyst is required. Customary in large industrial scale plants are temperatures of 200° C. and 330° C. at a very much lower reaction rate.

An intermediate condensation may allow a very high yield since ammonia can be withdrawn from the equilibrium. In addition, cascading or repetition may, for example, result in a total ammonia yield at 400° C., 500 bar and, for example, five passes of up to 99%.

In addition, the isothermicity of reaction apparatus 10 ensures controllability and precisely predictable behavior (without hot spots/cold spots). The isothermicity of the reactor also allows precise operation of the catalyst without causing damage. In addition, the reaction apparatus 10 can be made particularly compact, wherein heating and cooling are made possible with a particularly low energy demand and keeping warm even when not in operation is made possible at only low thermal loss. The reaction apparatus 10 is manufactured monolithically especially also from a high-performance alloy and thus as a material system is very resistant and tough and also very corrosion-resistant even at high temperatures, while nevertheless allowing precise formation of small structures. The isothermicity of the process and thus in the reaction apparatus 10 may be made possible via a salt melt or the heat pipe temperature control unit, for example with naphthalene as the working medium, which may be operated up to about 450° C.

Current plants with additive manufacturing allow for example an installation volume of 0.6 m³, with the result that for example a reaction apparatus 10 can be designed such that 216 liters are addressable, of which 25 to 50 liters may be implementable as catalyst bed.

Some embodiments provide improved thermal efficiency, so that only small amounts of heat are dissipated into a cold cooling water where they are lost for utilization. From an exergetic standpoint heat is employed in the system or the reaction apparatus 10 only at the required temperature level. High-temperature heat is extracted and can be utilized. This makes it possible to achieve greater than 95% yield without a recycle gas compressor, wherein only one compression of a cold gas is carried out. Exergetic efficiency results for example in a robust eco design.

Mechanically and in assembly the process is likewise easy to implement or the reaction apparatus 10 to operate, since, for example, few connecting conduits are provided and no seals and thus no leakage risks are made possible during the transition between individual heat exchange units 24, 26, 28 and the preheating unit 36. Additive manufacturing also makes it possible to process a high-performance alloy such as IN625 in the required fragility, so that a particularly compact design is also made possible, and compared to conventional plants, where reactors may have a diameter of 4 m for example, a high pressure of 500 bar at 500° C. may be realized.

In some embodiments, the condensation means 16 makes it possible to implement a multifunctional monomaterial so that the reaction apparatus 10 is particularly simple to recycle—this makes it possible to readily achieve for example a closed loop for reactor body disassembly which is particularly desirable especially for high-value alloys. An ionic compressor is also particularly efficient and decentralized heat utilization is made possible.

Decentralized renewable energy generated in the area may be utilized by the proposed process and the reaction apparatus 10, thus allowing for example decentralized production of fertilizer without release of CO₂.

### LIST OF REFERENCE NUMERALS

10 Reaction apparatus
12 Reactor means
14 Feed gas
16 Condensation means
18 Heat sink
19 Wet gas
20 Condensate
22 Dry gas
24 First heat exchange unit
26 Second heat exchange unit
28 Third heat exchange unit
30 Collection channel
32 Reaction space
34 First reactor
35 Second reactor
36 Preheating unit
38—Heat exchange reservoir
40—Heat recovery reservoir
42 Solid plates
44 Plate channel
46 Porous demister plate
48 Solid plate
50 Porous collector plate
52 Cooling channel
54 Condensation direction
56 End range
58 Electrolyzer
60 Electricity
62 Compressor
64 Phase separator
66 Catalyst

1. A process for ammonia synthesis, the process comprising:
passing a feed gas via an inlet opening over a catalyst within a reactor, wherein the feed gas comprises nitrogen and hydrogen under pressure;
passing ammonia produced in the reactor as a wet gas to a condensation unit comprising at least three heat exchangers configured monolithically with one another, wherein the ammonia condenses;
wherein the first heat exchanger includes a countercurrent cooler to cause the wet gas to exchange heat with a dry gas from which ammonia has already condensed, thereby producing a cooled wet gas;
the second heat exchanger includes a condenser to separate the wet gas into gaseous reactants and a liquid pressurized condensate; and
the third heat exchanger includes an aftercooler to subcool the liquid pressurized condensate; and
discharging the subcooled liquid pressurized condensate through a collection channel and discharging the dry gas via an outlet opening.

2. The process as claimed in claim 1, wherein the reactor comprises a reaction space configured monolithically with the condensation unit comprising: a preheating unit and a second reactor surrounded by a heat pipe heat exchange reservoir and of first reactor surrounded by a heat pipe heat recovery reservoir to preheat the feed gas and bring the feed gas to reaction.

3. The process as claimed in claim 1, wherein:
the reaction space comprises a pressure vessel; and
the feed gas is introduced into the reaction space at a pressure of at least 300 bar.

4. The process as claimed in claim 1, further comprising generating pressure applied to the feed gas using an ionic compressor.

5. The process as claimed in claim 1, wherein a plurality of reactor passes are performed successively in a cascade, and to this end especially a corresponding number especially monolithically manufactured reaction apparatuses are connected in series.

6. A reaction apparatus for ammonia synthesis, the apparatus comprising:
a reactor; and
a condenser unit including at least three heat exchangers configured monolithically with one another;
wherein the first heat exchanger comprises a countercurrent cooler;
the second heat exchanger comprises a condenser; and
the third heat exchanger comprises an aftercooler.

7. The reaction apparatus as claimed in claim 6, wherein:
the first heat exchanger includes a plurality of solid plates arranged spaced apart from one another in parallel and wherein respective sets of two adjacent plates form a respective plate channel;
the second heat exchanger includes porous demister plates which in each case seamlessly extend the plates of the first heat exchanger; and
the third heat exchanger includes alternating apposed solid plates and porous collection plates arranged substantially perpendicular to the plates of the first and second heat exchangers and comprise at least one cooling channel and in an end region in a condensation direction comprise a collection channel.

8. The reaction apparatus as claimed in claim 6, further comprising a plurality of reactors and condensation units formed as one piece and/or additively manufactured individually.

9. The reaction apparatus as claimed in claim 6, wherein a material of the reactor and/or of the condensation unit exhibits long-term stability towards high pressure and/or high temperature and/or ammonia and/or hydrogen and/or nitrogen.

10. The reaction apparatus as claimed in claim 6, wherein the material comprises NiCr22Mo9Nb and/or NiCr19Fe19Nb5Mo3 and/or has a thermal conductivity of less than 15 W/(m*K).
